(19) United States
(12) Patent Application Publication
(10) Pub. No.: US 2026/0074198 A1
(43) Pub. Date: Mar. 12, 2026

(54) MONOLITHIC WOOD-DERIVED CATHODES FOR LITHIUM SULFUR BATTERIES

(71) Applicant: UNIVERSITY OF WYOMING, Laramie, WY (US)

(72) Inventors: Erica BELMONT, Laramie, WY (US); Kurt STAHLFELD, Laramie, WY (US)

(21) Appl. No.: 18/871,361

(22) PCT Filed: Jun. 5, 2023
(86) PCT No.: PCT/US2023/024445

§ 371 Date: Dec. 3, 2024

Related U.S. Application Data
(60) Provisional application No. 63/348,844, filed on Jun. 3, 2022.

(51) Int. Cl. H01M 4/36; H01M 4/02; H01M 4/04; H01M 4/38; H01M 4/583; H01M 4/66; H01M 10/052

(52) U.S. Cl. CPC H01M 4/366; H01M 4/0454; H01M 4/0471; H01M 4/0492; H01M 4/38; H01M 4/583; H01M 4/663; H01M 2004/021; H01M 2004/028; H01M 10/052

(57) ABSTRACT

Embodiments described herein relate to a method comprising soaking a wood in a mild acid, soaking the wood in an iron containing solution, pyrolizing the wood, heat treating the wood to create a graphitized monolith, leaching the graphitized monolith to remove iron remaining in the graphitized monolith, and infiltrating the graphitized monolith with sulfur to create a cathode. Embodiments described herein relate to a method of fabricating a sulfur-carbon composite cathode as shown and described herein. Embodiments described herein relate to a sulfur-carbon composite cathode as shown and described herein.

### BACKGROUND

### Field

Embodiments of the present disclosure generally relate to battery technology. More specifically, embodiments described herein relate to fabricating lithium-sulfur batteries using sulfur-carbon composite cathodes from woody biomass.

### Description of the Related Art

There is increasing need for transportation decarbonization and rising consumer interest in electric vehicles (EVs), but higher cost and lower range vehicles, when compared to internal combustion engine (ICE) vehicles, have severely restricted consumer adoption of EVs. These range and cost limitations are due in large part to the low gravimetric energy density and high cost of current lithium batteries.

Lithium batteries (LiBs), of which there is one predominant chemistry in commercial use and many more under investigation, generally function by moving lithium (Li) ions between two electrodes: an anode and a cathode. Li is stored in a high-energy state in the anode and, as the battery discharges, Li ions and electrons flow from the anode to the cathode. The flow of electrons generates the current that the battery ultimately produces. Current commercial LiBs use graphite as the anode material due to the ability of graphite to reversibly intercalate lithium. Current cathodes also use intercalation chemistry, with cobalt, nickel, and aluminum oxides being the most commonly used cathode materials. Such cathode chemistries adequately stabilize lithium, but the high mass of these metal oxides significantly reduces performance of the battery cell. Nickel and cobalt also have the disadvantages of cost and availability. The high cost of nickel and cobalt contributes significantly to the overall cost of LiBs, with cathode materials accounting for over 30% of the total LiB cell production cost. There are serious concerns about the availability of cobalt as the growth of the electric vehicle market increases LiB demand, with over 60% of world cobalt production occurring in the Democratic Republic of the Congo.

Current lithium batteries using graphite anodes and metal oxide cathodes have energy densities of 160-260 Wh·kg⁻¹ on a full cell basis. Further increases in gravimetric energy density beyond 350 Wh·kg⁻¹ are likely not possible with current electrode materials due to the limited number of crystallographic sites available for insertion of lithium ions.

Lithium-sulfur (Li—S) chemistry can be used as a replacement for current LiBs. Li—S batteries utilize a sulfur cathode and an anode such as lithium metal, graphite, or silicon. Octa sulfur (cyclo-S₈) is the most stable allotrope of sulfur at room temperature and is readily lithiated. As sulfur is lithiated during discharge, lithium polysulfides with the general formula Li₂Sₓ (x=2, 4, 6), are formed. During discharge, sulfur is lithiated to first form polysulfide Li₂S₈, after which lithiation continues and the Li₂S₈ is further lithiated forming Li₂S₆ and Li₂S₄. These polysulfide species are highly soluble in the ether-based electrolytes commonly used in Li—S batteries. Li₂S₄ can be further lithiated to produce insoluble Li₂S₂ and Li₂S. These reactions are reversible and during charging these species are delithiated to form S₈. The ability of sulfur to bond multiple lithium ions results in a cathode capacity potential of 1,672 mAh·g⁻¹ and a full cell gravimetric energy density potential of 2,500 Wh·kg⁻¹, substantially higher than commercial lithium-ion cells which currently offer approximately 160-260 Wh·kg⁻¹.

Despite their potential for much higher performance, Li—S batteries faces three main challenges: (1) Low electrical conductivity of sulfur. Sulfur is highly electrically insulating, having an electrical conductivity of 10⁻¹⁶ S·m⁻², preventing bulk sulfur from being used as a cathode due to the high electrical resistance that would result. (2) Volume change upon lithiation. At standard conditions, the S₈ allotrope is the most prevalent and accounts for the vast majority of sulfur in the cathode. During discharge, S₈ is progressively lithiated to form Li₂S, with a volume increase of about 80%. This volume increase can cause cracking of cathode pores leading to destruction of the cathode. (3) Diffusion of polysulfides. Lithium polysulfides (PS) with the formula Li₂S_{x (x=2,4,6)} generated during discharge are soluble in battery electrolyte. These PS species diffuse away from the cathode and can react with the anode and electrolyte leading to capacity loss; this phenomenon is often referred to as the polysulfide shuttle and results in very poor cycle life.

These challenges have typically been addressed by supporting sulfur on a porous electrically conductive scaffold, typically composed of carbon. The electrically conductive scaffold permits the flow of electrons to sulfur, and pores in the carbon provide space for expansion of sulfur during lithiation. Diffusion of PS can be prevented by difficult to manufacture nanometer-sized pores that physically contain PS species and by surface modifications that serve to bind PS species to the supporting scaffold. Many efforts have been made to construct sulfur cathodes with high gravimetric energy density, long cycle life, and low production costs, but commercially available Li—S cells are currently limited by low cycle life and exhibit only moderately improved gravimetric energy density compared to conventional LiBs.

Most Li—S batteries have focused on cathode development, as this component is the primary impediment to Li—S implementation. Most Li—S cathode construction involves production of a carbon scaffold followed by sulfur addition. A wide variety of carbon scaffolds have been produced including graphene sheets, carbon nanotubes, carbon fibers, and fullerenes. Carbon scaffolds are frequently modified by surface additions including gold nanoparticles, various forms of titanium, nickel, and other metals. These surface modifications increase the polarity of the carbon surface helping to bind lithium polysulfides (PS) and prevent the detrimental polysulfide shuttle. Following scaffold production, sulfur is added to the scaffold material by a process called melt infiltration: scaffold material and sulfur are mixed and then heated. As the viscosity of sulfur reaches a minimum at this temperature, sulfur fills the pores of the carbon scaffold. The expensive carbon scaffold materials and synthesis methods in this approach can produce small amounts (e.g., milligrams) of high-performance cathode material for laboratory testing in coin cells, but it is unlikely these methods can economically scale to the hundreds or thousands of tons per year necessary for commercial relevance.

Accordingly, what is needed in the art are low-cost, high-energy density batteries.

### SUMMARY

In one embodiment, a method is shown. The method includes soaking a wood in a mild acid, soaking the wood in an iron containing solution, pyrolizing the wood, heat treating the wood to create a graphitized monolith, leaching the graphitized monolith to remove iron remaining in the graphitized monolith, and infiltrating the graphitized monolith with sulfur to create a cathode.

A method or forming a cathode is provided. The method includes soaking a wood in a mild acid, soaking the wood in an iron containing solution, pyrolizing the wood, heat treating the wood to create a graphitized monolith, leaching the graphitized monolith to remove iron remaining in the graphitized monolith, and infiltrating the graphitized monolith with sulfur to form a cathode.

In another embodiment, a sulfur-carbon composite cathode is formed according to the methods described herein.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 is a process schematic of a wood-derived cathode production method, according to embodiments described herein.

FIG. 2 is a graph illustrating sulfur content in mass percentage of monolithic cathodes that are sulfur-infiltrated at various temperatures for 1 hour, according to embodiments described herein.

FIG. 3 is a graph illustrating the specific capacity on a cathode basis and Coulombic efficiency of the monolithic cathodes cycled at C/4 over 100 cycles, according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to battery technology. More specifically, embodiments described herein relate to fabricating lithium-sulfur batteries using sulfur-carbon composite cathodes from woody biomass.

The disclosure generally relates to a wood-derived monolithic cathode that is liquid or vapor infiltrated with sulfur to produce high energy density batteries at low cost while utilizing readily available biomass. Lithium sulfur (Li—S) batteries are highly attractive for many energy storage applications due to their high gravimetric energy density and low cost of sulfur compared to current cathode materials ($150/ton vs $10,000/ton). To date, technical challenges have prevented significant commercial adoption of Li—S chemistry, with current Li—S batteries having only moderate improvements in gravimetric energy density and extremely short cycle life (<100 cycles). In one embodiment, a method to produce Li—S cathodes from wood is described herein. The method enables the production of high gravimetric energy density Li—S batteries with long cycle life at low cost.

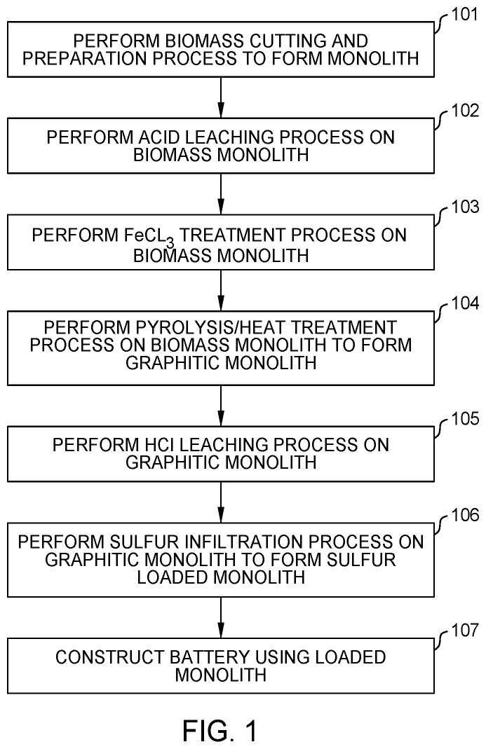

FIG. 1 is a process schematic of wood-derived cathode production method 100. The method 100 produces monolithic carbon-sulfur cathodes from wood with high gravimetric energy density, low cost, and long cycle life. At operation 101, a biomass cutting and preparation process is performed to form a monolith. In one embodiment, the biomass is wood. It is contemplated that other woody material or biomass may also be utilized in accordance with the embodiments described herein. The wood is shaped to approximately the geometry of the desired cathode. Any desirable shape, geometry, and dimensions may be utilized to form the cathode from the wood. In one embodiment utilized to create a coin cell, the wood is cut into about 4 cm thick sections, which are cored using a hole saw to create cores which are 1.9 cm in diameter. The cores are then formed into discs of about 1.9 cm diameter by 4 mm in thickness.

At operation 102, an acid leaching process is performed on the biomass monolith. In certain embodiments, operation 102 is optional depending upon the biomass utilized. In one embodiment, wood is soaked in a mild acid to reduce mineral content. In one embodiment, the acid is a 1% acetic acid solution (w/w), and the wood is soaked for 24 hours. In other embodiments, different concentrations of acetic acid solution may be utilized with different soak time periods. For example, the acetic acid concentration may range from about 0.1% to about 10%, depending upon the type of biomass to be demineralized. As described above, operation 102 is optional when a biomass is utilized where demineralization is not desirable or the mineral content and profile of the biomass is chemically suitable for cathode formation.

At operation 103, an FeCl₃ treatment process is performed on the biomass monolith. In one embodiment, the biomass monolith (wood) is soaked in FeCl₃ to aid in catalytic graphitization. The catalytic graphitization process is utilized to transform non-graphitic carbon (biomass monolith, such as wood, prior to FeCl₃ treatment) into a graphitic material. It is believed that the graphitization process of the biomass is catalyzed by the iron moiety and such a treatment improved the rate and degree of graphitization. While FeCl₃ is described herein, it is contemplated that other metals and metal solutions may be utilized to perform operation 103. In one embodiment, an FeCl₃ solution is used to treat the biomass monolith. In one embodiment, the FeCl₃ solution (w/w) is between about 1% and about 99%, between about 10% and about 90%, between about 20% and about 80%, between about 30% and about 70%, between about 40% and about 60%, between about 10% and about 50%, between about 20% and about 40%, between about 50% and about 90%, between about 60% and about 80%, between about 25% and about 75%, between about 35% and about 65%, or between about 45% and about 55%. The time period of the FeCl₃ treatment is between about 1 minute about 72 hours, such as between about 1 hour and about 60 hours, between about 12 hours and about 48 hours, between about 12 hours and about 36 hours, between about 18 hours and about 30 hours, such as about 24 hours. It is contemplated that different combinations of FeCl₃ concentration may be utilized with different durations of treatment depending upon the type of biomass monolith being treated and the desired degree of graphitization.

At operation 104, a pyrolysis/heat treatment process is performed on the biomass monolith to form a graphitic monolith. The wood, which after operation 103 may be considered a graphitic monolith, is pyrolyzed using a heating rate to a maximum temperature and heat treated at a similar heating rate in an inert environment to create a graphitized monolith. In one embodiment, the heating rate is about 10° C./min and the maximum temperature is about 500° C. and the heat treatment maximum temperature is about 1,200° C. In other embodiments, the heating rate is between about 1° C./min and about 100° C./min, between about 5° C./min and about 75° C./min, between about 10° C./min and about 50° C./min, or between about 20° C./min and about 40° C./min. In other embodiments, the maximum heat treatment during heat ramp up is between about 200° C. and about 800° C., between about 250° C. and about 750° C., between about 300° C. and about 700° C., between about 350° C. and about 650° C., between about 400° C. and about 600° C., or between about 450° C. and about 550° C. In other embodiments, the maximum heat treatment temperature is between about 800° C. and about 1,600° C., between about 850° C. and about 1,550° C., between about 900° C. and about 1,400° C., between about 950° C. and about 1,350° C., between about 1,000° C. and about 1,300° C., or between about 1,150° C. and about 1,250° C.

In one embodiment, the wood is pyrolyzed in N₂. Other inert gases, such as argon or other noble gases, may also be used in place of N₂. In one embodiment, the pyrolysis and heat treating are performed in the same operation. In another embodiment, the pyrolysis and heat treating are performed in separate operations due to the liquid products involved during pyrolysis. A stainless steel reactor may be utilized for pyrolysis, as that reactor can be readily cleaned of reactive and viscous liquid products involved during pyrolysis. It is also noted that liquid byproducts of the pyrolysis process are removed from the reactor and may be subsequently utilized to form other useful products.

In one embodiment, the heat treatment temperature of 1,200° C. may use a ceramic-lined furnace that can be damaged by liquid pyrolysis products. By performing pyrolysis separate from heat treatment, a high temperature furnace may be protected from harmful liquid products. Heat treatment converts pyrolyzed wood into a graphitized monolith with high specific surface area to enable sulfur addition into pores or the graphitized monolith. The graphitized monolith also has high electrical conductivity in order to enable the carbon scaffold to function as a current collector. The graphitized monolith further exhibits high graphitic content to provide minimal electrical resistance within the cathode.

In one embodiment, the graphitized monolith has a specific surface area of greater than about 400 m²/g, such as greater than about 450 m²/g, greater than about 500 m²/g, greater than about 550 m²/g, greater than about 600 m²/g, greater than about 650 m²/g, greater than about 700 m²/g, or greater than about 750 m²/g. In another embodiment, the graphitized monolith has an electrical conductivity of greater than 1,000 S/m, such as greater than about 1,050 S/m, greater than about 1,100 S/m, greater than about 1,150 S/m, greater than about 1,200 S/m, or greater than about 1,250 S/m. In another embodiment, the graphitized monolith has a graphitic content greater than 40%, such as greater than about 45%, greater than about 50%, greater than about 55%, greater than about 60%, greater than about 70%, or greater than about 75%. The surface area and pore characteristics of the carbon scaffold can be tailored through addition of small amounts of oxidizer for short durations during pyrolysis and/or heat treatment.

Temperatures approaching 3,000° C. are utilized to non-catalytically graphitize the biomass monolith. As described herein, the addition of iron, either as metallic iron or FeCl₃ in operation 103, enables catalytic graphitization of lignocellulosic biomass at 1,200° C. Heat treatment at 1,200° C. serves to create a microporous structure within the carbon monolith, i.e., heat treatment produces activated carbons with BET surface areas exceeding 1,000 m²/g, with most pores smaller than about 3 nm. During pyrolysis and heat treatment, wood loses a majority of its mass resulting in moderate shrinkage of the monolith. The graphitized monolith is then formed to the desired cathode geometry, such as by sanding. Other formation process, such as cutting, or the like are also contemplated to form the desired cathode geometry. In one embodiment, the graphitized monolith is a graphitic disc with a diameter about 17 mm and a thickness about 1 mm.

At operation 105, an HCl leaching process is performed on the graphitic monolith. The graphitized monolith is leached using HCl, which removes the remaining iron in the graphitized monolith. In one embodiment, the HCl is a 37% HCl solution (w/w). In other embodiments, the HCl solution is between about 20% and about 80%, between about 20% and about 70%, between about 25% and about 60%, between about 30% and about 50%, or between about 35% and about 45%. Graphite content is evaluated using Raman spectroscopy and electrical conductivity is evaluated using a two-probe technique. Graphitized monoliths may also be analyzed by physisorption (BET analysis) to determine their pore size distribution and surface area. Graphitized monoliths formed according to the embodiments described herein exhibit most volume existing at small pore widths, with about 1 nm pores being typical, although other pore widths are observed and contemplated.

At operation 106, a sulfur infiltration process is performed on the graphitic monolith to form a sulfur loaded monolith. Sulfur is infiltrated into the graphite monoliths using high-pressure vapor or liquid infiltration. A plurality of graphitic monoliths are either suspended above the sulfur for vapor infiltration or in contact with the sulfur for liquid infiltration. In one embodiment, the reactor is heated to about 100° C. for 1 hour while vacuum is applied, degassing and removing any gas or water adsorbed into the fine pore structure of the monoliths. The reactor is then isolated from the vacuum source, heated to a final temperature of up to about 800° C., and held at temperature for about one hour. It is contemplated that lower temperatures may be utilized as the final temperature, such as The normal boiling point of sulfur is 446° C. and, at about 800° C., the vapor pressure of sulfur reaches about 38 atm (560 psi). At this elevated temperature, S₈ (the allotrope of sulfur that exists at room temperature and pressure (RTP)), begins to dissociate into smaller isotopes S₆, S₄, and S₂. Sulfur vapor infiltration at elevated temperature enables sulfur to penetrate further into the micropores of the cathode scaffold, enabling higher sulfur loading and better retainment of sulfur to prevent diffusion of PS. For liquid infiltrated monoliths, the sulfur loaded graphitic monoliths (i.e., cathodes) are then removed from the reactor and heated in a vacuum oven at 150° C. to remove any loosely bound sulfur that would interfere with battery cycling. It is contemplated that the temperature of the drying process may be altered to achieve drying without substantially changing the characteristics (other than moisture content) of the sulfur loaded cathode.

The cathodes may be analyzed by thermogravimetric analysis (TGA) to examine the bonds between the sulfur and the pore structure of the carbon scaffold. Sulfur evaporates at 446° C., and observation of mass loss at higher temperatures demonstrates that sulfur is strongly bonded to the carbon scaffold in cathodes formed according to the embodiments described herein. The cathodes are also analyzed using scanning electron microscopy (SEM) with energy dispersive X-ray spectroscopy (EDX) to examine the distribution of sulfur within the disc, i.e., the amount of sulfur across the depth of the disc.

Cathodes with high sulfur contents suffer from poor cycle life because excessive sulfur is poorly bound to the cathode and escapes, resulting in the polysulfide shuttle. Additionally, poor sulfur utilization within the cathode can occur. Conversely, cathodes with low sulfur and high scaffold carbon contents can have long cycle life but suffer from low capacity due to the low total sulfur content in the cathode. Proper cathode design indicates that the sulfur content of the cathode is of a high enough concentration to provide good capacity, yet sufficient scaffold content is included to support and retain sulfur during cycling. The method 100 at operation 107 also includes constructing a battery using the sulfur loaded monolith. Cathodes fabricated according to the embodiments described herein exhibit sulfur loading greater than about 25%, such as between about 30% and about 50%, such as about 35%. This degree of sulfur loading is contemplated to meet or exceed the performance of currently utilized metal oxide cathode materials while also maintaining a significant amount of carbon scaffold content for sulfur retention and extended cycle life. Moreover, the utilization of woody biomass as a feedstock for cathode production enables a renewable battery cathode source material.

Cathodes produced according to the embodiments described herein exhibit a specific capacity of about 300 mAh/g after 100 cycles. Such a specific capacity corresponds to the specific energy equivalent of conventional metal oxides, and is significantly higher than complete metal oxide cathodes considering conductivity additive, binder, and metallic current collector masses. The capacity of an Li—S cathode is given by equation (1):

$$Capacity = 1672 m Ah \cdot {g}^{- 1} \times {M}_{S} \times {U}_{S}$$

Where Mₛ is the fractional sulfur loading and Uₛ is the fractional sulfur utilization. The method 100 produces a cathode having a sulfur utilization of greater than about 25%, such as greater than about 50%, such as about 52%, and a sulfur loading of about 35%, as mentioned above.

The main factors preventing mass adoption of electric vehicles (EVs) are short range and high cost compared to their internal combustion engine (ICE) counterparts. The use of Li—S batteries made using method 100 supplies high gravimetric energy density at low production costs, enabling manufacturers to produce EVs that are competitive with ICE vehicles and providing for mass implementation of EVs. Further, the use of the method 100 secures a domestic supply chain for battery components. Large amounts of cobalt are required for LiBs, and most cobalt is sourced from volatile nations abroad, with over 60% of the world cobalt production being supplied by the Democratic Republic of the Congo. By producing Li—S cathodes from woody biomass and sulfur, abundant supplies of which exist within the United States, a secure and reliable supply chain is established for advanced batteries.

Further still, the woody biomass utilized can be sourced from relatively low-quality, non-merchantable wood that may not find value as timber, which further improves and supports forest management operations, subsequently reducing fire impacts to certain regions of the country.

In an exemplary non-limiting embodiment, batteries utilizing the cathodes of method 100 is constructed using Li foil as the anode and Celgard® 2340 separator. The electrolyte is composed of a 50/50 vol/vol % solution of 1,3-dioxolane (DOL) and dimethoxyethane (DME) containing 1M lithium bis(trifluoromethanesulfonyl)imide (LiTFSI) and 0.2M LiNO₃. A DOL/DME binary mixture is used as electrolyte in Li—S cells as these compounds are more inert to reactions with polysulfides compared to conventional electrolytes. LiTFSI is used as the primary electrolyte salt as LiTFSI forms a stable solid electrolyte interface (SEI) on lithium metal anodes. LiTFSI has the additional advantages of high dissociation and diffusivity in DOL/DME mixtures which enables fast cycling rates. LiNO₃ is added as a secondary lithium salt as LiNO₃ has been shown to form a passivation layer on Li metal anodes that helps to hinder the polysulfide shuttle, resulting in greater charge/discharge efficiency and long cycle life.

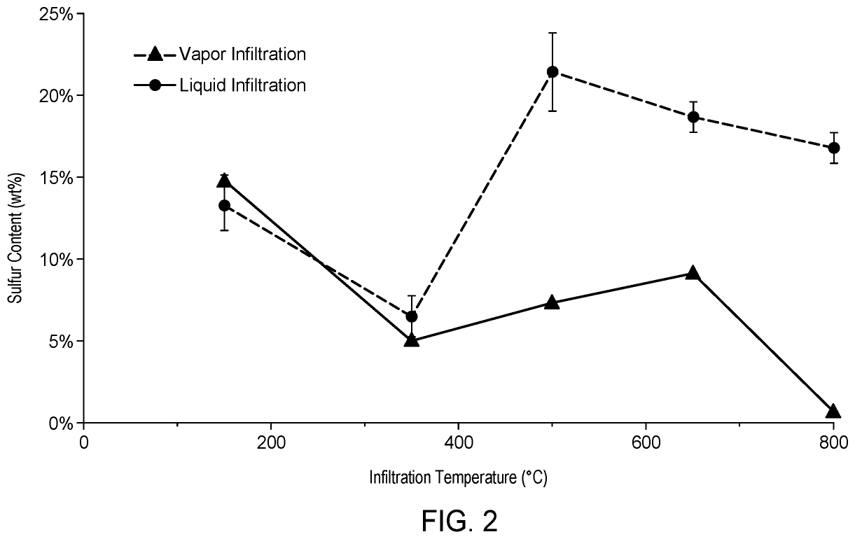

FIG. 2 is a graph illustrating sulfur content in mass percentage of monolithic cathodes that are sulfur-infiltrated at various temperatures for 1 hour. Infiltration of the cathodes at 650° C. showed that liquid and vapor infiltration produced sulfur loadings between about 7.5% and about 10% for vapor infiltrated cathodes and between about 17.5% and about 20% for liquid infiltrated cathodes.

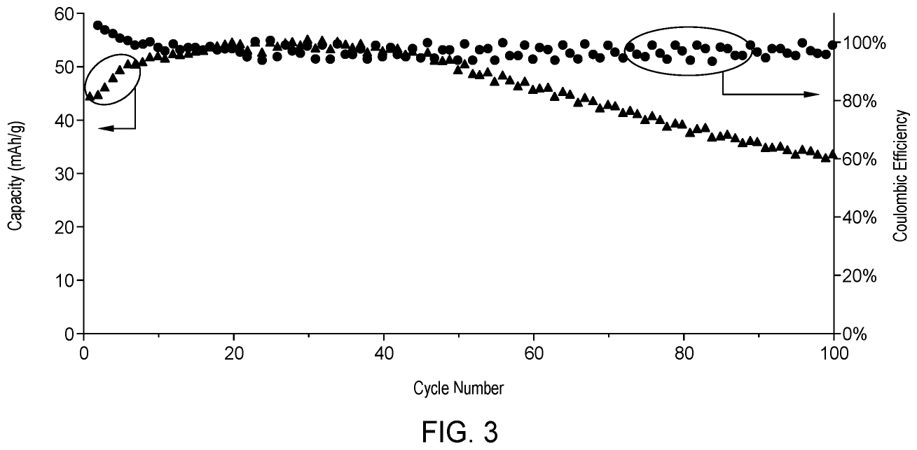

FIG. 3 is a graph of the specific capacity on a cathode basis and Coulombic efficiency of the monolithic cathodes cycled at C/4 over 100 cycles. The capacity and Coulombic efficiency over the cycling showed a cathode-basis specific capacity of 54 mAh/g. Though no metallic current collector was used, the gravimetric energy density of the cathode was comparable to an active material with a capacity of 84 mAh/g supported on a metallic foil. Coloumbic efficiency was greater than 95% per cycle.

While the foregoing is directed to embodiments of the present disclosure, other and further embodiments of the disclosure may be devised without departing from the basic scope thereof, and the scope thereof is determined by the claims that follow.

What is claimed is:

1. A method or forming a cathode, comprising:
soaking a wood in a mild acid;
soaking the wood in an iron containing solution;
pyrolizing the wood;
heat treating the wood to create a graphitized monolith;
leaching the graphitized monolith to remove iron remaining in the graphitized monolith; and
infiltrating the graphitized monolith with sulfur to form a cathode.

2. The method of claim 1, wherein the cathode has a specific capacity of at least 300 mAh/g after 100 battery cycles.

3. The method of claim 1, wherein the graphitized monolith has a specific surface area greater than 400 m²/g.

4. The method of claim 1, wherein the graphitized monolith has an electrical conductivity greater than 1000 S/m.

5. The method of claim 1, wherein the graphitized monolith has a graphitic content greater than 30%.

6. The method of claim 1, wherein the mild acid is acetic acid.

7. The method of claim 6, wherein the iron containing solution is FeCl₃.

8. The method of claim 7, wherein pyrolyzing the wood comprises:
a pyrolysis process performed at a maximum temperature of about 800° C.; and
a heat treatment process performed at a temperature of greater than about 1,000° C.

9. The method of claim 8, where in a heat ramping rate during the pyrolysis process is between about 1° C. and about 20° C.

10. The method of claim 1, wherein the leaching the graphitized monolith comprises contacting the graphitized monolith with HCl.

11. The method of claim 1, wherein the infiltrating the graphitized monolith comprises a vapor sulfur infiltration process.

12. The method of claim 1, wherein the infiltrating the graphitized monolith comprises a liquid sulfur infiltration process.

13. The method of claim 1, further comprising:
shaping the cathode to a desired battery morphology.

14. The method of claim 1, wherein the cathode comprises a BET surface area exceeding 1,000 m²/g.

15. A sulfur-carbon composite cathode, fabricated in accordance with the method of claim 1.
